(19) United States
(12) Patent Application Publication
(10) Pub. No.: US 2004/0016876 A1
(43) Pub. Date: Jan. 29, 2004

(54) Method of etching semiconductor device using neutral beam and apparatus for etching the same

(76) Inventors: Geun-Young Yeom, Seoul (KR); Daebaing Lee, Suwon-city (KR)

Correspondence Address: CANTOR COLBURN LLP, 55 Griffin Road South, Bloomfield, CT, 06002, US

(21) Appl. No.: 10/628,939

(22) Filed: Jul. 28, 2003

Related U.S. Application Data
(62) Division of application No. 10/010,548, filed on Nov. 8, 2001.

(30) Foreign Application Priority Data
Nov. 22, 2000 (KR) 2000-69660

(51) Int. Cl. H01S 1/00

(52) U.S. Cl. 250/251

(57) ABSTRACT

A method and an apparatus for etching a semiconductor device which can perform an etching process without causing electrical and physical damages using a neutral beam generated by a simple apparatus. In the method, ions of an ion beam having a predetermined polarity are extracted from an ion source and accelerated. An accelerated ion beam is reflected by a reflector and neutralized. A substrate to be etched positioned in the path of the neutral beam in order to etch a special material layer on the substrate with the neutral beam. The gradient of the reflector is adjusted to control an angle of incidence of the ion beam incident on the reflector, and a voltage is applied to the reflector to control the path of an incident ion beam.

### BACKGROUND OF THE INVENTION

1. Field of the Invention

The present invention relates to a method of etching a semiconductor device and an apparatus for etching the same, and more particularly, to a method of etching a nanoscale semiconductor device and an apparatus for etching the same without damage by using a neutral beam.

2. Description of the Related Art

As an increase in the integration density of semiconductor devices has been required, the design rule of integrated semiconductor circuits has been reduced. Thus, a critical dimension of 0.25 μm or less is needed. Ion enhanced etching tools, such as a high density plasma etcher and a reactive ion etcher are mainly used as etching tools for realizing nanoscale semiconductor devices. In such case, high density ions having energies of a few hundred eV bombard a semiconductor substrate or a specific material layer on the semiconductor substrate for anisotropic etching. The bombardment of such ions causes physical and electrical damages to the semiconductor substrate or the specific material layer.

Examples of physical damage are as follows. A substrate or a specific material layer having crystallinity is transformed into an amorphous layer. Also, a specific material layer, on which some incident ions are adsorbed or bombarded, of which partial components are only selectively desorbed therefrom to change chemical composition of a surface layer to be etched. Atomic bonds of the surface layer are changed into dangling bonds by this bombardment. Dangling bonds may result in electrical damage as well as physical damage. As electrical damage, there is gate dielectric charge-up or polysilicon notching due to photoresist charging. Besides this physical and electrical damages, there is also possible contamination by materials of a chamber or the contamination of a surface layer by a reactive gas such as the generation of C-F polymers caused by the use of a CF-based gas.

Physical and electrical damages due to the bombardment of ions reduces the reliability of nanoscale semiconductor devices and productivity. New apparatuses and methods for etching semiconductor devices are required to be developed in order to cope with the trend toward further increases in the integration density of semiconductor devices and reductions in design rule due to increased integration density.

D. B. Oakes suggests a damage-free etching technique with a hyperthermal atomic beam in his thesis “Selective, Anisotropic and Damage-Free SiO₂ Etching with a Hyperthermal Atomic Beam”. Japanese Takashi Yunogami suggests a silicon oxide etching technique with a neutral beam or neutral radicals causes less damage in his thesis “Development of neutral-beam-assisted etcher” (J.Vac. Sci. Technol. A 13(3), May/June, 1995). M. J. Goeckner suggests an etching technique with a hyperthermal neutral beam having no charges instead of plasma in his thesis “Reduction of Residual Charge in Surface-Neutralization-Based Beams” (1997 2^{nd} International Symposium on Plasma Process-induced Damage, May 13-14, Monterey, Calif.).

In the damage-free etching technique by D. B. Oakes, since ions do not exist, it is expected that physical and electrical damages do not occur and contamination is low. However, scalability is difficult in that it is difficult to perform anisotropic etching on micro-devices, and etch rate is low. In the silicon etching technique by Takashi Yunogami, scalability is easy, but it is difficult to adjust the direction of the neutral beam and contamination possibility is high when extracting an ion beam. In the etching technique by M. J. Goeckner, scalability is possible and a high neutral beam flux can be obtained, but the direction of the neutral beam is not clear due to ion-electron recombination, ions are mixed, and contamination possibility is high when extracting ions.

### SUMMARY OF THE INVENTION

To solve the above-described problems, it is a first object of the present invention to provide a method of etching a semiconductor device which can perform an etching process without causing electrical and physical damages by the use of a neutral beam generated by installing only a simple apparatus and an apparatus for etching the large area by using the neutral beams.

It is a second object of the present invention to provide a damage-free method of etching a semiconductor device that can adjust the direction of a neutral beam to improve anisotropic etching by using only a simple apparatus and an apparatus for etching the large area.

Accordingly, to achieve the first object, there is provided a method of etching a semiconductor device using a neutral beam. An ion beam having a predetermined polarity is extracted from an ion source to accelerate the ion beam. An accelerated ion beam is reflected by a reflector to neutralize the reflected ion beam. A substrate to be etched is positioned in the path of a neutral beam to etch is a special material layer on the substrate with the neutral beam. The step of neutralizing the ion beams is performed after adjusting the angle of incidence of the ion beam incident on the reflector. The angle of incidence of the ion beam incident on the reflector is within the range of 75-85° from the vertical line to the horizontal surface of the reflector. The step of neutralizing the ion beam is performed after adjusting the gradient of the reflector to an incident ion beam. The step of neutralizing the ion beam is performed after applying a voltage to the reflector to adjust the path of an incident ion beam.

To achieve the second object, there is provided an apparatus for etching a semiconductor device using a neutral beam. The apparatus includes: an ion source for extracting and accelerating an ion beam having a predetermined polarity; a reflector positioned in the path of the ion beam accelerated from the ion source for reflecting and neutralizing the ion beam; and a stage for positioning a substrate to be etched in the path of the neutral beam. The ion source is an inductively coupled plasma source, and a grid is formed to accelerate the ion beam at the rear of the ion source. An ion beam blocker having a slit passing only ions is included within a predetermined range between the ion source and the reflector.

The reflector is formed of a plate which may be tilted to adjust the angle of incidence of an incident ion beam to the horizontal surface of the plate. The reflector is formed of a plurality of cylindrical reflectors, which are overlapped, of which adjacent reflectors have different polarities. The position of the stage is adjusted to the path of the neutral beams reflected by the reflector. The reflector is a semiconductor substrate, a silicon dioxide substrate, and a metal substrate.

According to the present invention, a reflector for reflecting an ion beam at a predetermined angle of incidence is included between an ion source generating an ion beam and a stage in which a substrate to be etched is installed. Thus, a neutral beam can be obtained by a simple method. An etching process can be easily performed for a nanoscale semiconductor device without causing electrical and physical damages to a substrate to be etched using the neutral beam, and scalability is easy.

Also, an acceleration voltage of an ion beam may be controlled in an ion source. Only ions within a predetermined range may be incident on a reflector through a slit in an ion beam blocker. The gradient of reflectors or voltages applied to the reflectors may be controlled to adjust the direction of the neutral beam. Thus, a more improved anisotropic etching process can be performed.

Further, only ions having a predetermined direction are extracted to drastically reduce contamination generated due to the bombardment of unnecessary ions on the inner walls of a chamber.

### BRIEF DESCRIPTION OF THE DRAWINGS

The above objects and advantages of the present invention will become more apparent by describing in detail preferred embodiments thereof with reference to the attached drawings in which:

FIG. 1 is a schematic diagram of an apparatus for etching a semiconductor device using a neutral beam according to a first embodiment of the present invention;

FIG. 2 is a cross-section of a substrate to be etched as shown in FIG. 1;

FIG. 3 is a perspective schematic diagram of an apparatus for etching a semiconductor device using a neutral beam according to a second embodiment of the present invention;

FIG. 4 is a graph showing variations in etch rate with respect to acceleration voltage resulting from an etching process according to the first embodiment of the present invention;

FIG. 5 is a graph showing variations in etch rate with respect to incident angle resulting from the etching process according to the first embodiment of the present invention;

FIG. 6 is a graph showing variations in etch rate with respect to RF power resulting from the etching process according to the first embodiment of the present invention; and

FIG. 7 is a scanning electron microscope (SEM) micrograph of an etch pattern resulting from the etching process according to the first embodiment of the present invention.

### DETAILED DESCRIPTION OF THE INVENTION

Hereinafter, embodiments of the present invention will be described in detail with reference to the attached drawings. However, the embodiments of the present invention may be modified into various other forms, and the scope of the present invention must not be interpreted as being restricted to the embodiments. The embodiments are provided to more completely explain the present invention to those skilled in the art.

<First Embodiment>

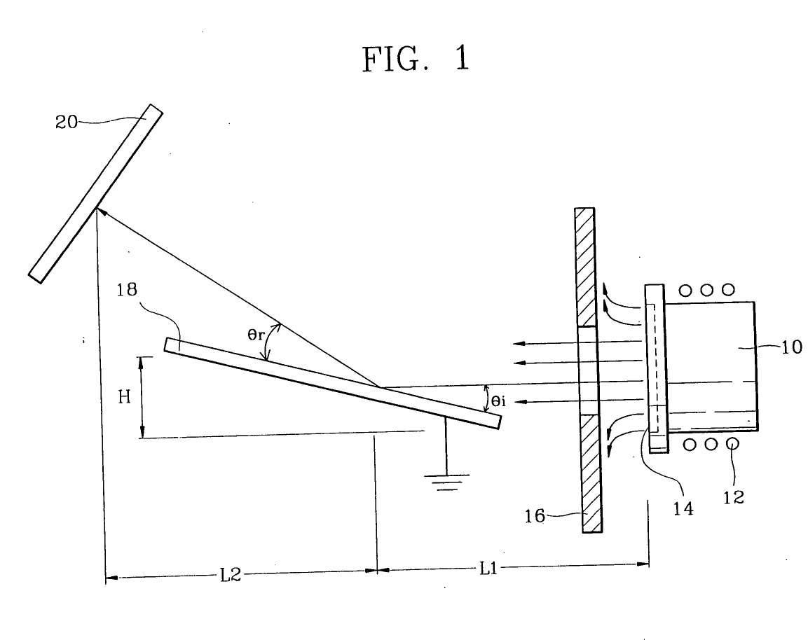

FIG. 1 is a schematic diagram of an apparatus for etching a semiconductor device according to a first embodiment of the present invention. FIG. 1 is a simplified diagram to explain the principle of the present invention, and elements shown in FIG. 1 are included in a chamber under moderate vacuum.

Describing an etching method of the present invention, an ion beam having a predetermined polarity is extracted from an ion source and then accelerated. An accelerated ion beam is reflected by a reflector and neutralized into a neutral beam. A substrate to be etched is positioned in the path of the neutral beam to etch a specific material layer on the substrate by the neutral beam.

Theoretical mechanism of the reflection of the accelerated ion beam by the reflector and then the transformation of the reflected ion beam into the neutral beam is based on a thesis “Molecular dynamics simulations of Cl²⁺ impacts onto a chlorinated silicon surface: Energies and angles of the reflected Cl₂ and Cl fragments” (J.Vac. Sci. Technol. A 17(5), September/October 1999) by B. A. Helmer and D. B. Graves. According-to this thesis, when Cl²⁺ ions are incident on a silicon substrate having a chloride (Cl) monolayer at an angle higher than a critical incidence angle, the Cl²⁺ ions may be neutralized. Also, the distribution of reflected neutral Cl₂ molecules and Cl atomic fragments to Cl₂ molecules incident at the angle of incidence of 85° is represented as a polar angle and an azimuthal angle, respectively. This thesis shows that nearly 90% or more of ions that are incident at an angle within a predetermined range are reflected as neutral atoms or neutral molecules and the azimuthal angle of the reflected particles is close to 0°.

The present invention applies preferred conditions and forms to a process of etching nanoscale semiconductor device based on the theoretical mechanism, and an etching method.

An etching apparatus of the present invention will be described with reference to FIG. 1. Referring to FIG. 1, an ion source 10 generates an ion beam. The ion beam passes through a slit having a predetermined diameter. The slit is positioned at the rear of the ion source 10 in the path of the ion beam. The ion beam is reflected by a reflector 18 and neutralized into a neutral beam. The neutralized ion beam is incident on a substrate 20 to be etched in order to etch a specific material layer on the substrate 20. The ion source 10 may generate the ion beam from a variety of reactive gases. An inductively coupled plasma (ICP) generator, which applies an inductive power to an induction coil 12 to generate plasma, is used in the present embodiment. A variety of transformed ion sources may be used instead. A voltage is applied to the end of the ion source 10 to accelerate the ion beam. A grid 14 having a plurality of holes is formed so that ions of the ion beam penetrate through the plurality of holes.

An ion beam blocker 16 with a slit having a circular or rectangular shape of a predetermined diameter at the centre of the ion beam blocker 16 is disposed at the rear of the ion source 10. The ion beam blocker 16 passes ions that have a predetermined direction and are within a predetermined range of the ion beam accelerated by the ion source 10 and blocks other ions from entering chamber to prevent contamination caused by the bombardment of unnecessary ions on the inner walls of the chamber or components of the chamber. Also, it prevents the neutral beam reflected by the reflector 18 from bombarding unnecessary ions and then dispersing, which would inhibit an anisotropic etching process with the neutral beam.

A reflector 18 is slanted to the horizontal plane to reflect ions that passed through the slit. The reflector 18 can be tilted so that the gradient of the reflector 18 is adjusted within an appropriate range. It is preferable that the reflector 18 is grounded to discharge charges generated by an incident ion beam. The reflector 18 may take various shapes, e.g., rectangular or circular, and may be formed of a silicon semiconductor substrate, a substrate having silicon oxide on the surface, or a metal substrate. The reflector 18 may be a plurality of substrates spaced apart from each other and each having a predetermined size in consideration of the area required for passing the ion beam extracted from the ion source 10 and in consideration of the gradient of the reflector 18 or may be a single substrate.

The gradient and size of the reflector 18 may be adjusted according to the size of the slit of the ion beam blocker 16. In other words, the ion beam passed through the slit has a projected area that is entirely within the reflector 18 so that all of the ions of the ion beam passed through the slit are reflected by the reflector 18. The gradient of the reflector 18 may be adjusted within a range of at least 5-15° to the horizontal plane in the present embodiment. The gradient of the reflector 18 to the horizontal plane is nearly equal to the angle of incidence θi or the angle of reflection θr to the horizontal surface of the reflector 18, as shown in FIG. 1. Thus, the gradient of at least 5-15° to the horizontal plane means the angle of incidence to the vertical line is at least 75-85°.

A substrate 20 to be etched is disposed in the path of the ion beam neutralized due to the reflection by the reflector 18. The substrate 20 to be etched may be mounted on a stage (not shown) to be disposed in a vertical direction to the path of the neutral beam. The direction and position of substrate 20 to be etched may be adjusted and slanted at a predetermined angle depending on the kind of etching process. As shown in FIG. 1, length L1 from the rear of the ion source 10 to the centre of the reflector 18 is equal to length L2 from the substrate 20 to the centre of the reflector 18, i.e., lengths L1 and L2 are 10 cm in this embodiment. The length from the rear of the ion source 10 to the substrate 20 to be etched may be arbitrary.

A retarding grid (not shown) for controlling ion flux is installed at an appropriate position between the grid 14 and the substrate 20 to be etched, e.g., at any place between the stage (or faraday cup) on which the substrate 20 is positioned and the reflector 18.

An etching process for the present invention may use one of a variety of gases, instead of one specific gas, depending on the kind of material layer to be etched and the kind of etch masks. For example, the reactive gas may be Cl₂, Cl₂/C₂F₆, SiCl₄, CCl₄/O₂, or SiCl4/O₂, when silicon is etched using a silicon oxide layer as an etch mask. The reactive gas may be Cl₂/SiCl₄, Cl₂/CCl₄, Cl₂/CHCl₃, or Cl₂/BCl₃ when aluminum is etched using a silicon oxide layer, a silicon nitride layer, or a photoresist layer as an etch mask.

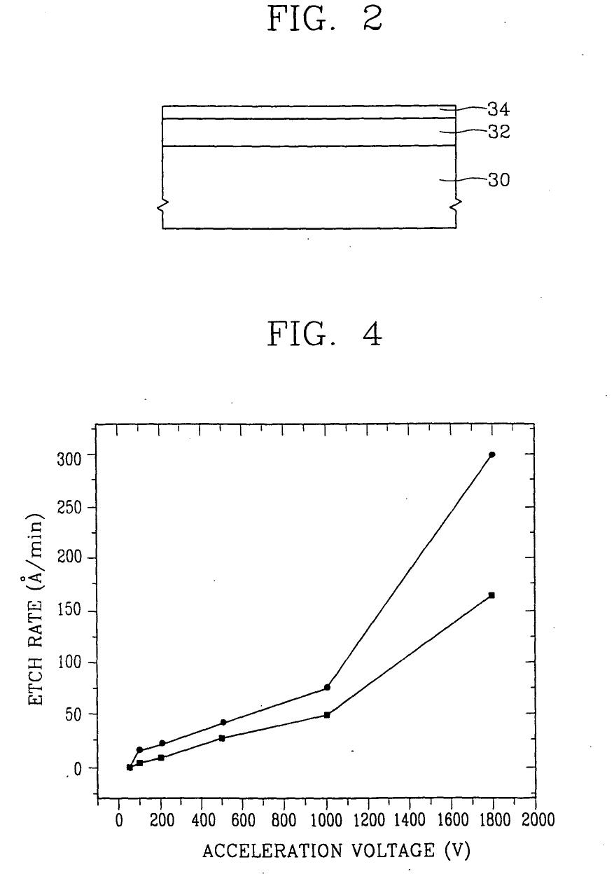

FIG. 2 is a cross-section of the substrate to be etched shown in FIG. 1 which shows variations in etch rate depending on the conditions of the etching process of the present invention. Referring to FIG. 2, a material layer 32 to be etched is formed on a semiconductor substrate 30. An etch mask layer 34 having a predetermined pattern is formed on the material layer 32 to be etched. A silicon substrate is coated with a photoresist layer, i.e., the material layer 32 to be etched, on which a bar-shaped chrome layer, i.e., the etch mask layer 34, is patterned.

FIG. 4 is a graph showing variations in etch rate with respect to acceleration voltage resulting from the etching process according to the first embodiment of the present invention. Here, the horizontal axis indicates an acceleration voltage applied to the grid 14 of FIG. 1 to extract and accelerate the ion beam. The vertical axis indicates the etch rate of the photoresist layer. An inductive power of 250 W is applied to the induction coil 12 of the ion source 10, the angle of incidence θi to the horizontal surface of the reflector 18 is 5°, and O₂ as a plasma reaction gas flows at a rate of 4 sccm. “●” represents etching of the photoresist layer with an ion beam unneutralized as in the prior art, and “▪” represents etching of the photoresist layer with a neutral beam reflected by the reflector 18 as in the present invention. FIG. 4 shows that etch rate difference varies slowly up to an acceleration voltage of 1000 V and increases drastically for voltages greater than 1000V.

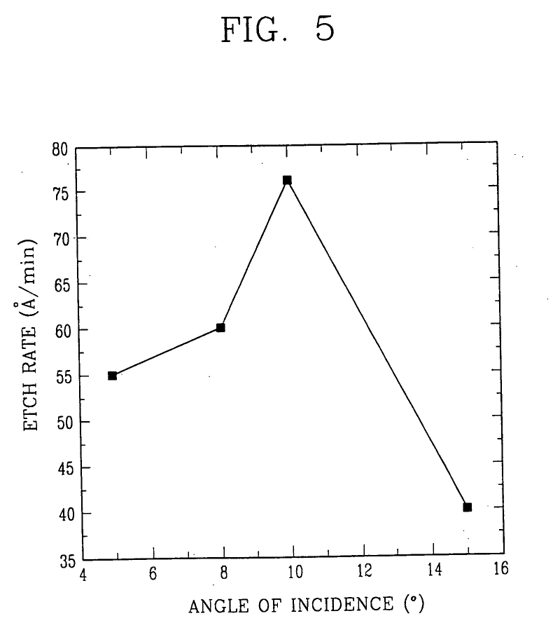

FIG. 5 is a graph showing variations in etch rate with respect to the angle of incidence resulting from the etching process according to the first embodiment of the present invention. Here, the horizontal axis indicates the angle of incidence θi with respect to the horizontal surface of the reflector 18 shown in FIG. 1, and the vertical axis indicates etch rate of the photoresist layer. An inductive power of 300 W is applied to the induction coil 12 of the ion source 10. Acceleration voltage is 1000V, and O₂ as a plasma reaction gas flows at a rate of 4 sccm. Etch rate is at its maximum, i.e., about 75 Å/min, when the angle of incidence is 10°.

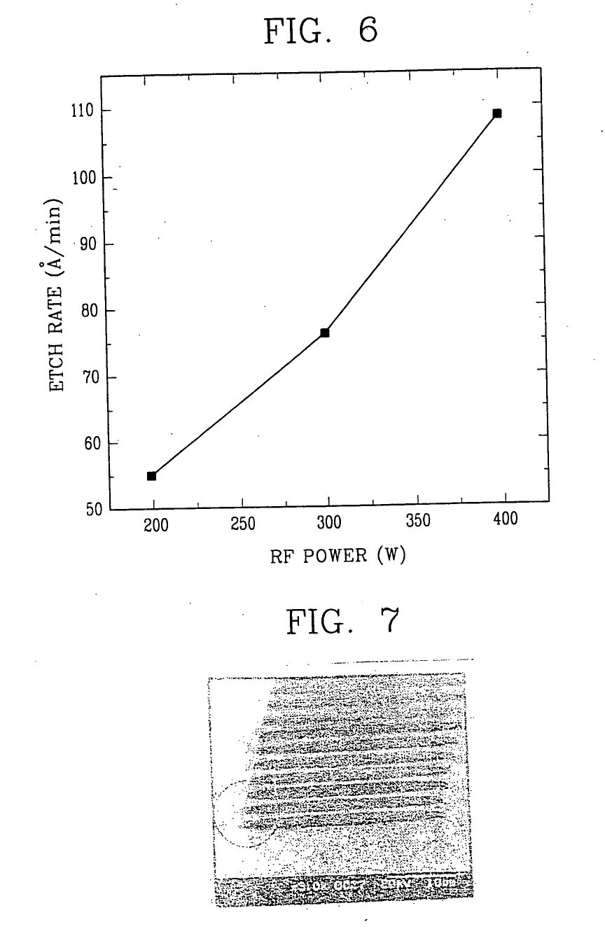

FIG. 6 is a graph showing variations in etch rate with respect to RF power resulting from the etching process according to the first embodiment of the present invention. Here, the horizontal axis indicates inductive power applied to the induction coil 12, and the vertical axis indicates etch rate of the photoresist layer. The angle of Incidence θi with respect to the horizontal surface of the reflector 18 is 10°, an acceleration voltage of 1000V is applied to the grid 14, and O₂ as a plasma reaction gas flows at a rate of 4 sccm. FIG. 6 shows that increasing the RF power increases the etch rate.

FIG. 7 is a-scanning electron microscope (SEM) micrograph of etch patterns resulting from the etching process according to the first embodiment of the present invention. Here, black bar-shaped patterns indicate photoresist layers that are inhibited from being etched by chrome layers, which have been are removed therefrom. Other patterns indicate photoresist layers that are etched to a predetermined depth.

In the present embodiment, when ion currents were measured at the faraday cup in which the substrate 20 to be etched is placed, depending on whether the reflector 18 of FIG. 1 exists or not, the ion currents increased drastically with increases in acceleration voltage and RF power in the prior art having no reflector. The ion currents were close to zero for all conditions when the ion currents were measured with varying acceleration voltage and RF power in the present invention. This means that the ions of the ion beam are nearly completely neutralized by the reflector 18 of the present invention.

The increase in ion currents was not remarkable for all acceleration voltage and RF power conditions when the ion currents were measured with varying length between the grid 14 and the substrate 20 to be etched.

The increase of retarding grid potential decreased the ion currents detected at the faraday cup and nearly zero ion current was detected above the potential close to the acceleration voltage when the ion currents were measured at the faraday cup with varying the retarding grid potential.

<Second Embodiment>

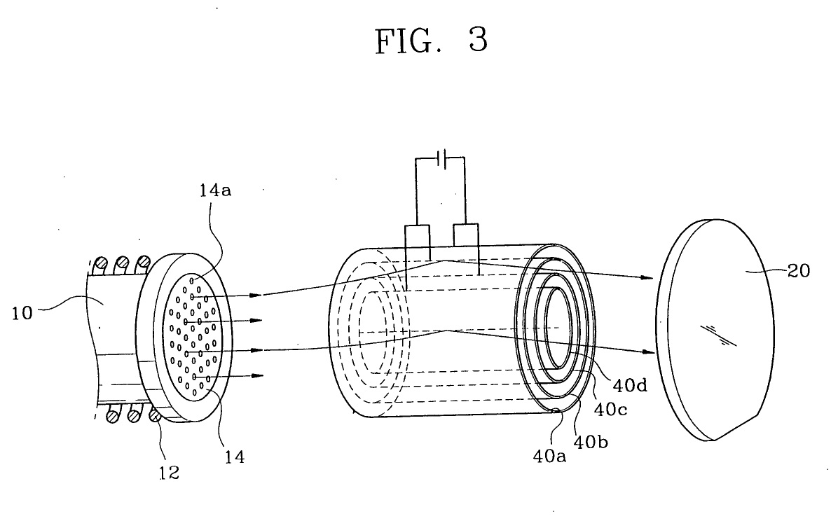

FIG. 3 is a perspective schematic diagram of an apparatus for etching a semiconductor device according to a second embodiment of the present invention. FIG. 3 is a simplified drawing to explain the principles of the present invention. Components of FIG. 3 are included in a chamber under moderate vacuum as in FIG. 1. An etching method according to the second embodiment is similar to the first embodiment except for the shape of a reflector and a method of reflecting the ion beam. In other words, an ion beam having a predetermined polarity is extracted from an ion source and then accelerated. An accelerated ion beam is reflected by a plurality of cylindrical reflector, of which adjacent cylindrical reflectors have different polar voltages, to be neutralized. A substrate to be etched is positioned in the path of a neutral beam to etch a specific material layer on the substrate to be etched by the neutral beam. Like reference numerals in FIG. 1 denote the same members and the detailed descriptions thereof are omitted.

Referring to FIG. 3, the ion beam is extracted from an ion source 10. The ion beam is reflected by a plurality of cylindrical reflectors which are positioned at the rear of the ion source 10 in the path of the ion beam. A reflected ion beam is neutralized into a neutral beam. The neutral beam is incident on a substrate 20 to be etched in order to etch a specific material layer on the substrate 20. An ion beam blocker 16 (not shown in FIG. 3) including a slit having a predetermined diameter may be placed between the ion source 10 and the cylindrical reflectors.

A voltage may be applied to the end of the ion source 10 to accelerate the ion beam. A grid 14 having a plurality of holes 14a through which ions of the ion beam pass may be provided.

A plurality of cylindrical reflectiors 40a, 40b, 40c, and 40d which overlap radially are included between the ion source 10 and the substrate 20 in the present embodiment. Adjacent reflectors of the plurality of cylindrical reflectors 40a, 40b, 40c, and 40d have different polar voltages. Thus, ions having a predetermined polarity are repulsed from reflectors having the same polarity as said ions when the ion beam passes through the plurality of cylindrical reflectors 40a, 40b, 40c, and 40d. In contrast, the ions are attracted to reflectors having a different polarity from said ions, so said ions are reflected by such reflectors. The reflected ion beam passes through the plurality of cylindrical reflectors 40a, 40b, 40c, and 40d to perform an etching process on the substrate 20. The lengths radii, and voltages of the plurality of cylindrical reflectors 40a, 40b, 40c, and 40d may be adjusted according to design. The plurality of cylindrical reflectors 40a, 40b, 40c, and 40d may be formed of the same material as the reflector in the first embodiment, preferably, a conductive material.

In the present embodiment, the plurality of cylindrical reflectors may be slanted so that they are tilted within a physical range. Preferably, the strengths of the voltages applied to the plurality of cylindrical reflectors can be controlled. In other words, the trajectory of the ion beam can be controlled by controlling the mass, speed, and the angle of incidence of the incident ion beam and the magnitude of electromagnetic fields in the plurality of cylindrical reflectors. The incident ion beam traveling in a parabolic path bombard the surfaces of the plurality of cylindrical reflectors and then are transformed into neutral beam. The neutral beam moves in a straight line. Here, the angle of incidence of the ion beam to the longitudinal axis of the plurality of cylindrical reflectors may be adjusted within the range of at least 5-150°.

An etching process of the present embodiment may use various reaction gases depending on the kind of material layer to be etched and the kind of etch mask.

Although the invention has been described with reference to the first and second embodiments, it will be apparent to one of ordinary skill in the art that modifications to the described embodiments may be made without departing from the spirit and scope of the invention. For example, the shape of an ion source, the kind of reaction gas, and the material of a reflector may be modified.

According to the present invention, a neutral beam can be obtained by a simple method. An etching process can be easily performed for a nanoscale semiconductor device without causing electrical and physical damages to a substrate to be etched using the neutral beam, and scalability is easy.

Also, the gradient of reflectors or voltages applied to the reflectors may be controlled to adjust the direction of the neutral beam. Thus, a more improved anisotropic etching process can be performed.

Further, only ions having a predetermined direction are extracted to drastically reduce contamination generated due to the bombardment of unnecessary ions on the inner walls of a chamber.

What is claimed is:

1. An apparatus for etching a semiconductor device using a neutral beam, the apparatus comprising:
an ion source for extracting and accelerating an ion beam having a predetermined polarity;
a reflector positioned in a path of the ion beam accelerated from the ion source for reflecting and neutralizing the ion beam; and
a stage for positioning a substrate to be etched in a path of the neutral beam.

2. The apparatus of claim 1, wherein the ion source is an inductively coupled plasma source.

3. The apparatus of claim 1, wherein the reflector comprises a plurality of plates which are spaced apart from each other to reflect the ion beam.

4. The apparatus of claim 1, wherein the reflector comprises a plate which is tiltable to adjust an angle of incidence of an incident ion beam to a horizontal surface of the plate.

5. The apparatus of claim 1, wherein the reflector comprises a plurality of cylindrical reflecting members.

6. The apparatus of claim 1, further comprising a position control means for adjusting a position of the stage corresponding to the path of the neutral beams reflected by the reflector.

7. The apparatus of claim 1, wherein the reflector is selected from the group consisting of a semiconductor substrate, a silicon dioxide substrate, and a metal substrate.

8. The apparatus of claim 1, further comprising an ion beam blocker having a slit passing only ions within a predetermined range between the ion source and the reflector.

9. The apparatus of claim 7, further comprising a retarding grid between the reflector and the stage.

10. The apparatus of claim 1, wherein the ion source comprises a grid at a rear of the ion source.

11. The apparatus of claim 5, wherein the cylindrical reflecting members are overlapped, and adjacent reflectors have different polarities.
